(19) United States
(12) Patent Application Publication
(10) Pub. No.: US 2020/0191449 A1
(43) Pub. Date: Jun. 18, 2020

(54) Magnetic Heat Pump Device

(71) Applicant: SANDEN HOLDINGS CORPORATION, Isesaki-shi (JP)

(72) Inventor: Sangchul BAE, Isesaki-shi (JP)

(73) Assignee: SANDEN HOLDINGS CORPORATION, Iseaki-shi, Gunma (JP)

(21) Appl. No.: 16/349,557

(22) PCT Filed: Oct. 20, 2017
(86) PCT No.: PCT/JP2017/037911

§ 371 Date: May 13, 2019

(30) Foreign Application Priority Data
Nov. 14, 2016 (JP) 2016-221640

(51) Int. Cl. F25B 21/00; H01F 1/01

(52) U.S. Cl. CPC F25B 21/00; H01F 1/012

(57) ABSTRACT

A magnetic heat pump device (1) has magnetic working bodies (11A to 11D), a permanent magnet (6), a circulating pump (24), rotary valves (8, 9), and heat exchangers (21, 28). A plurality of types of magnetic working substances (13A to 13C) is charged into a duct (12) of each of the magnetic working bodies in the ascending order of the Curie points from a low-temperature end (16) to a high-temperature end (14), whereby the magnetic working substances are connected in cascade and a dimension in which each of the magnetic working substances is charged is made to correspond to a predetermined specific temperature range in which the temperature change is large thereof. By effectively connecting the plurality of types of the magnetic working substances in cascade, required cooling and heat dissipation temperatures can be obtained.

### TECHNICAL FIELD

The present invention relates to a magnetic heat pump device utilizing a magnetocaloric effect of magnetic working substances.

### BACKGROUND ART

A magnetic heat pump device utilizing a property that magnetic working substances cause a large temperature change in magnetization and demagnetization (magnetocaloric effect) has drawn attention in recent years in place of a conventional vapor compression refrigerating device using a gas refrigerant, such as chlorofluorocarbon. Heretofore, a Gd-based second order phase transition material has been used as the magnetic working substances. In recent years, however, an Mn-based or La-based second order phase transition material having a magnetic entropy change larger than that of the Gd-based material has been utilized (for example, see Patent Document 1).

The Mn-based and La-based magnetic working substances have large magnetic entropy changes by magnetization and demagnetization and also have high heat absorption/heat dissipation capabilities but have a disadvantage that the operating temperature region is narrow and a required temperature change cannot be obtained when used alone. Thus, it is considered that a plurality of magnetic working substances, the Curie points of which range from a low Curie point to a high Curie point, is charged into a duct in cascade connection, and then the temperature is changed from room temperature to a required refrigerating temperature or hot-water supply temperature (heat dissipation temperature).

### CITATION LIST

### Patent Documents

Patent Document 1: Japanese Patent Application Laid-Open No. 2008-51409

### SUMMARY OF THE INVENTION

### Problems to be Solved by the Invention

In actuality, however, an effective cascade connection of the magnetic working substances in a duct has not been quantitatively examined, heretofore.

The present invention has been accomplished in order to solve the conventional technical problems. It is an object of the present invention to provide a magnetic heat pump device capable of obtaining a required cooling or heat dissipation temperature by effectively connecting a plurality of types of magnetic working substances in cascade.

### Means for Solving the Problems

A magnetic heat pump device of the present invention is provided with a magnetic working body obtained by charging a magnetic working substance having a magnetocaloric effect into a duct in which a heat transfer medium is circulated, a magnetic field changing device changing the size of a magnetic field to be applied to the magnetic working substance, a heat transfer medium moving device moving the heat transfer medium between a high-temperature end and a low-temperature end of the magnetic working body, a heat exchanger on the heat dissipation side for causing the heat transfer medium on the high-temperature end side to dissipate heat, and a heat exchanger on the heat absorption side for causing the heat transfer medium on the low-temperature end side to absorb heat, in which two or more types of the magnetic working substances are connected in cascade by charging the magnetic working substances into the duct of the magnetic working body in the ascending order of the Curie points from the low-temperature end to the high-temperature end and the dimension in which each of the magnetic working substances is charged is made to correspond to a specific temperature range in which the temperature change is large of each of the magnetic working substances.

In a magnetic heat pump device of the invention of claim 2, the specific temperature range in which the temperature change is large of each of the magnetic working substances is a range from a half temperature on the high temperature side of the half width to the temperature at which the magnetic entropy change reaches a peak value of each of the magnetic working substances in the invention described above.

In a magnetic heat pump device of the invention of claim 3, the specific temperature range in which the temperature change is large of each of the magnetic working substances is a range in which, when each of the magnetic working substances is charged into the duct alone, the temperature change is larger than that in another portion between the low-temperature end and the high-temperature end when the temperature change is saturated in the invention described above.

In a magnetic heat pump device of the invention of claim 4, the magnetic working substances are charged into the duct so that the specific temperature ranges of the magnetic working substances are connected in order from lowest to highest in each of the above-described inventions.

In a magnetic heat pump device of the invention of claim 5, each of the magnetic working substances is a material having a magnetic entropy change larger than that of a Gd-based material but having an operating temperature region narrower than that of the Gd-based material in each of the above-described inventions.

In a magnetic heat pump device of the invention of claim 6, each of the magnetic working substances is an Mn-based or La-based material in each of the above-described inventions.

In a magnetic heat pump device of the invention of claim 7, the duct is configured by a resin in each of the above-described inventions.

### Advantageous Effect of the Invention

According to the present invention, in the magnetic heat pump device is provided with the magnetic working body obtained by charging the magnetic working substance having the magnetocaloric effect into the duct in which the heat transfer medium is circulated, the magnetic field changing device changing the size of the magnetic field to be applied to the magnetic working substance, the heat transfer medium moving device moving the heat transfer medium between the high-temperature end and the low-temperature end of the magnetic working body, the heat exchanger on the heat dissipation side for causing the heat transfer medium on the high-temperature end side to dissipate heat, and the heat exchanger on the heat absorption side for causing the heat transfer medium on the low-temperature end side to absorb heat, two or more types of the magnetic working substances are connected in cascade by charging the magnetic working substances into the duct of the magnetic working body in the ascending order of the Curie points from the low-temperature end to the high-temperature end and the dimension in which each of the magnetic working substances is charged is made to correspond to the specific temperature range in which the temperature change is large of each of the magnetic working substances. Therefore, even when the magnetic working substances having the large magnetic entropy change but having the narrow operating temperature region are used as with the invention of claim 5 or 6, a large temperature change is obtained from the temperature of the low-temperature end to the temperature of the high-temperature end by effectively connecting the magnetic working substances in cascade, so that the temperature is lowered to a cooling temperature or increased to a heat dissipation temperature required as a heat pump.

In this case, the specific temperature range in which the temperature change is large of each of the magnetic working substances in the invention described above is the range from a half temperature on the high temperature side of the half width to a temperature at which the magnetic entropy change reaches the peak value of each of the magnetic working substances as with the invention of claim 2.

The specific temperature range in which the temperature change is large of each of the magnetic working substances in the invention described above is the range in which, when each of the magnetic working substances is charged into the duct alone, the temperature change is larger than that in another portion between the low-temperature end and the high-temperature end when the temperature change is saturated as with the invention of claim 3.

When the magnetic working substances are charged into the duct so that the specific temperature ranges of the magnetic working substances are connected in order from lowest to highest as with the invention of claim 4, the largest temperature change can be obtained by most effectively connecting the magnetic working substances in cascade.

When the duct is configured by a resin as with the invention of claim 7, the heat loss to the outside from the magnetic working substance in which the temperature increases or decreases due to a change of a magnetic field can be reduced and heat can be prevented from flowing into the low-temperature end from the high-temperature end through the duct, and thus a temperature difference between the high-temperature end and the low-temperature end can be maintained.

### BRIEF DESCRIPTION OF THE DRAWINGS

FIG. 1 is an entire block diagram of a magnetic heat pump device of an example to which the present invention is applied.

FIG. 2 is a cross-sectional view of an AMR (Active Magnetic Regenerator) for the magnetic heat pump of FIG. 1.

FIG. 3 is a figure illustrating the temperatures of a high-temperature end and a low-temperature end of a magnetic working body in a state where the temperature change is saturated.

FIG. 4 is a T·(−ΔS) diagram illustrating the physical properties of magnetic working substances to be used in the magnetic heat pump device of FIG. 1.

FIG. 5 is a figure illustrating the physical properties of the magnetic working substances to be used in the magnetic heat pump device of FIG. 1 by the illustrated charging length and temperature in the duct.

FIG. 6 is a block diagram when a magnetic heat pump device having a 500 W refrigerating capacity is configured by a magnetic heat pump AMR for 500 W.

FIG. 7 is a block diagram when a magnetic heat pump device having a 500 W refrigerating capacity is configured by connecting five magnetic heat pump AMRs for 100 W in parallel.

### MODE FOR CARRYING OUT THE INVENTION

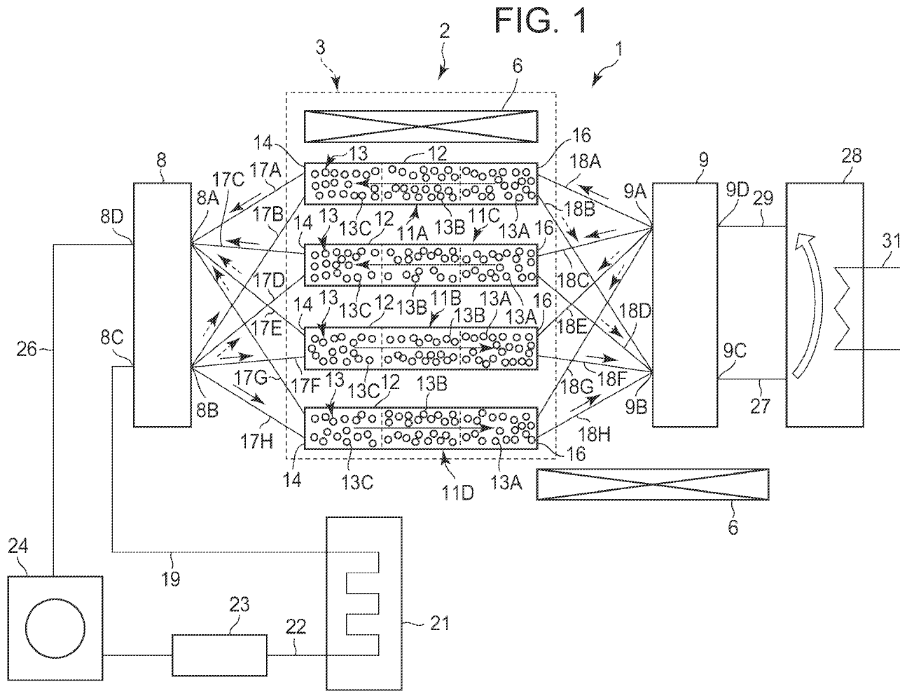

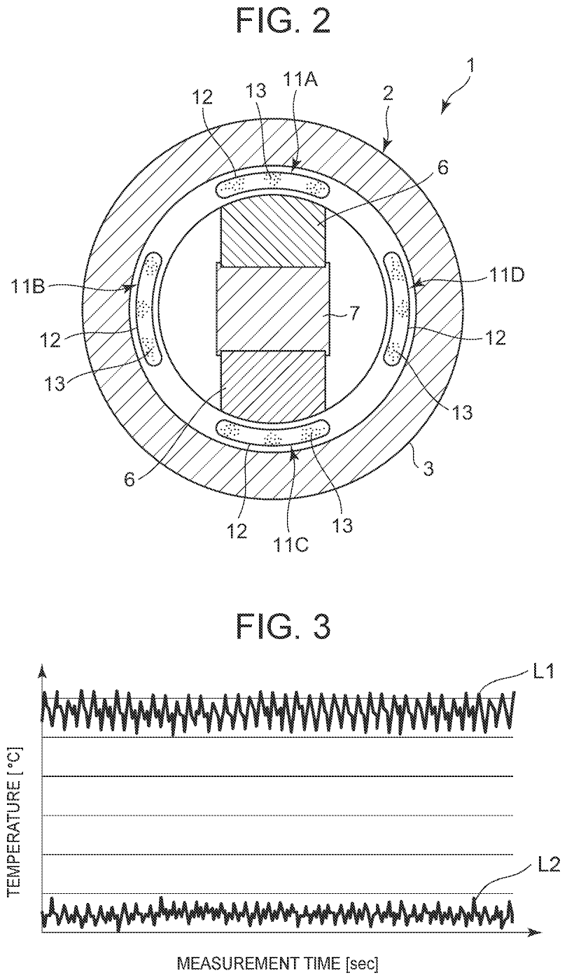

Hereinafter, one embodiment of the present invention is described based on the drawings. FIG. 1 illustrates an entire block diagram of a magnetic heat pump device 1 of an example to which the present invention is applied. FIG. 2 illustrates a cross-sectional view of a magnetic heat pump AMR 2 of the magnetic heat pump device 1. The target refrigerating capacity of the magnetic heat pump device 1 of the example is set to 100 W.

(1) Configuration of Magnetic Heat Pump Device 1

First, the magnetic heat pump AMR 2 of FIG. 2 is described. The magnetic heat pump AMR 2 of the magnetic heat pump device 1 is provided with a hollow cylindrical housing 3 and a rotating body 7 which is located in the axial center in the housing 3 and to which a pair (two pieces) of permanent magnets 6 (magnetic field generating member) are radially attached to axisymmetric peripheral surfaces. Both ends of a shaft of the rotating body 7 are revolvably and pivotally supported by the housing 3 and are coupled to a servo motor through a decelerator which is not illustrated and the revolution is controlled by the servo motor. The rotating body 7, the permanent magnets 6, and the like configure a magnetic field changing device changing the size of magnetic fields to be applied to magnetic working substances 13 described later. Moreover, rotary valves 8 and 9 (FIG. 1) described later are coupled to the shaft of the rotating body 7.

Meanwhile, four magnetic working bodies 11A, 11B, 11C, and 11D which are twice the number of the permanent magnets 6 are fixed to the inner periphery of the housing 3 at equal intervals in the circumferential direction in a state of approaching the outer peripheral surface of the permanent magnets 6. In the case of the example, the magnetic working bodies 11A and 11C are disposed at axisymmetric positions with the rotating body 7 interposed therebetween and the magnetic working bodies 11B and 11D are disposed at axisymmetric positions with the rotating body 7 interposed therebetween (FIG. 2). The magnetic working bodies 11A to 11D are those in which magnetic working substances 13 each obtained by connecting a plurality of types (three types in the example) of first to third magnetic working substances 13A, 13B, and 13C having a magnetocaloric effect in cascade are individually charged into a hollow duct 12 having a circular arc shaped cross section along the inner periphery of the housing 3 such that a heat transfer medium (herein water) can circulate (FIG. 1).

In the example, the duct 12 is configured by a resin material having a high heat insulation property. Thus, the heat loss to the atmosphere (outside) from the magnetic working substances 13 in which the temperature increases or decreases due to the change (magnetization and demagnetization) of the magnetic field is reduced and the heat transfer in the axial direction is prevented as described later. The magnetic working bodies 11A to 11D are described later in detail.

In the entire block diagram of the magnetic heat pump device 1 of FIG. 1 in which the magnetic heat pump AMR 2 is installed, each of the magnetic working bodies 11A to 11D has a high-temperature end 14 at one end (left end in FIG. 1) and has a low-temperature end 16 at the other end (right end in FIG. 1). High-temperature pipes 17A and 17B are connected to the high-temperature end 14 of the magnetic working body 11A. In the example, high-temperature pipes 17C and 17D are connected to the high-temperature end 14 of the magnetic working body 11C located at the axisymmetric position to the magnetic working body 11A and high-temperature pipes 17E and 17F are connected to the high-temperature end 14 of the magnetic working body 11B. In the example, high-temperature pipes 17G and 17H are connected to the high-temperature end 14 of the magnetic working body 11D located at the axisymmetric position to the magnetic working body 11B and each pipe is drawn out from the housing 3.

Low-temperature pipes 18A and 18B are connected to the low-temperature end 16 of the magnetic working body 11A. In the example, low-temperature pipes 18C and 18D are connected to the low-temperature end 16 of the magnetic working body 11C located at the axisymmetric position to the magnetic working body 11A and low-temperature pipes 18E and 18F are connected to the low-temperature end 16 of the magnetic working body 11B. In the example, low-temperature pipes 18G and 18H are connected to the low-temperature end 16 of the magnetic working body 11D located at the axisymmetric position to the magnetic working body 11B and each pipe is drawn out from the housing 3. A circulation path of the heat transfer medium (water) is configured from the pipes.

The high-temperature pipes 17A, 17C, 17E, and 17G of the magnetic working bodies 11A, 11C, 11B, and 11D, respectively, are connected to one connection port 8A of the rotary valve 8. The high-temperature pipes 17B, 17D, 17F, and 17H of the magnetic working bodies 11A, 11C, 11B, and 11D, respectively, are connected to the other connection port 8B of the rotary valve 8. The rotary valve 8 further has an outflow port 8C and an inflow port 8D and switches a state of causing the connection port 8A to communicate with the outflow port 8C and causing the connection port 8B to communicate with the inflow port 8D and a state of causing the connection port 8A to communicate with the inflow port 8D and causing the connection port 8B to communicate with the port outflow port 8C by the revolution of an internal valve element by the servo motor described above. The outflow port 8C of the rotary valve 8 is connected to the inlet of a heat exchanger 21 on the heat dissipation side through a pipe 19. The outlet of the heat exchanger 21 is connected to the suction side of a circulating pump 24 through a pipe 22 and a heater 23. The discharge side of the circulating pump 24 is connected to the inflow port 8D of the rotary valve 8 through a pipe 26, so that a circulation path on the heat exhaust side is configured.

On the other hand, the low-temperature pipes 18A, 18C, 18E, and 18G of the magnetic working bodies 11A, 11C, 11B, and 11D, respectively, are connected to one connection port 9A of the rotary valve 9. The low-temperature pipes 18B, 18D, 18F, and 18H of the magnetic working bodies 11A, 11C, 11B, and 11D, respectively, are connected to the other connection port 9B of the rotary valve 9. The rotary valve 9 further has an outflow port 9C and an inflow port 9D and switches a state of causing the connection port 9A to communicate with the outflow port 9C and causing the connection port 9B to communicate with the inflow port 9D and a state of causing the connection port 9A to communicate with the inflow port 9D and causing the connection port 9B to communicate with the port outflow port 9C by the revolution of an internal valve element by the servo motor described above.

The outflow port 9C of the rotary valve 9 is connected to the inlet of a heat exchanger 28 on the heat absorption side through a pipe 27 and the outlet of the heat exchanger 28 is connected to the inflow port 9D of the rotary valve 9 through a pipe 29, and a circulation path on the heat absorption side is configured. The circulating pumps 24, the rotary valves 8 and 9, and the pipes configure a heat transfer medium moving device causing a heat transfer medium to reciprocate between the high-temperature end 14 and the low-temperature end 16 of each of the magnetic working bodies 11A to 11D.

(2) Operation of Magnetic Heat Pump Device 1

The operation of the magnetic heat pump device 1 of the above-described configuration is described. First, when the rotating body 7 is located at the position of 0° (position illustrated in FIG. 2), the permanent magnets 6 and 6 are located at the positions of 0° and 180°. Therefore, the size of magnetic fields to be applied to the magnetic working substances 13 of the magnetic working bodies 11A and 11C at the positions of 0° and 180° increases and the temperature increases by magnetization. On the other hand, the size of magnetic fields to be applied to the magnetic working substances 13 of the magnetic working bodies 11B and 11D located at the positions of 90° and 270° having phases different therefrom by 90° decreases and the temperature decreases by demagnetization.

When the rotating body 7 is located at the position (FIG. 2) of 0°, the rotary valve 8 causes the connection port 8A to communicate with the port 8C and causes the connection port 8B to communicate with the inflow port 8D and the rotary valve 9 causes the connection port 9A to communicate with the inflow port 9D and causes the connection port 9B to communicate with the outflow port 9C.

Then, by the operation of the circulating pump 24, the heat transfer medium (water) is circulated in the order of the circulating pump 24→the pipe 26→from the inflow port 8D to the connection port 8B of the rotary valve 8→the high-temperature pipes 17F and 17H→the magnetic working bodies 11B and 11D at the positions of 90° and 270°→the low-temperature pipes 18F and 18H→from the connection port 9B to the outflow port 9C of the rotary valve 9→the pipe 27→the heat exchanger 28 on the heat absorption side→the pipe 29→from the inflow port 9D to the connection port 9A of the rotary valve 9→the low-temperature pipes 18A and 18C→the magnetic working bodies 11A and 11C at the positions of 0° and 180°→the high-temperature pipes 17A and 17C→from the connection port 8A to the outflow port 8C of the rotary valve 8→the pipe 19→the heat exchanger 21 on the heat dissipation side→the pipe 22→the heater 23→the circulating pump 24 as indicated by the solid line arrows in FIG. 1.

The heat media (water) in the magnetic working bodies 11A and 11C vibrate in the axial direction of the magnetic working bodies 11A and 11C, heat is transmitted to the high-temperature ends 14 from the low-temperature ends 16, the heat media (water) in which the temperature have become high at the high-temperature ends 14 flow out into the heat exchanger 21 on the heat dissipation side from the high-temperature pipes, the heat of the amount corresponding to the work is emitted to the outside (outdoor air or the like), and then the heat media (water) in which the temperature has become low at the low-temperature ends 16 flow out into the heat exchanger 28 on the heat absorption side from the low-temperature pipes to absorb heat from a cooling target body 31 to cool the cooling target body 31. More specifically, the heat media (water) cooled by dissipating heat to the magnetic working substances 13 of the magnetic working bodies 11B and 11D in which the temperature has decreased by demagnetization absorb heat from the cooling target body 31 with the heat exchanger 28 on the heat absorption side to cool the cooling target body 31. Thereafter, the heat media (water) absorb heat from the magnetic working substances 13 of the magnetic working bodies 11A and 11C in which the temperature has increased by magnetization to cool the same, return to the heat exchanger 21 on the heat dissipation side, and then emit the heat of the amount corresponding to the work to the outside (outdoor air or the like).

Next, when the rotating body 7 is revolved by 90° by the permanent magnets 6 and 6, the magnetic working substances 13 of the magnetic working bodies 11A and 11C located at the positions of 0° and 180° are demagnetized, so that the temperature decreases and the magnetic working substances 13 of the magnetic working bodies 11B and 11D at the positions of 90° and 270° are magnetized, so that the temperature increases. At this time, the valve elements of the rotary valves 8 and 9 are also revolved by 90° with the rotating body 7. Therefore, the heat media (water) are next circulated in the order of the circulating pump 24→the pipe 26→from the inflow port 8D to the connection port 8B of the rotary valve 8→the high-temperature pipes 17B and 17D→the magnetic working bodies 11A and 11C at the positions of 0° and 180°→the low-temperature pipes 18B and 18D→from the connection port 9B to the outflow port 9C of the rotary valve 9→the pipe 27→the heat exchanger 28 on the heat absorption side→the pipe 29→from the inflow port 9D to the connection port 9A of the rotary valve 9→the low-temperature pipes 18E and 18G→the magnetic working bodies 11B and 11D at the positions of 90° and 270°→the high-temperature pipes 17E and 17G→from the connection port 8A to the outflow port 8C of the rotary valve 8→the pipe 19→the heat exchanger on the heat dissipation side 21→the pipe 22→the heater 23→the circulating pump 24 as indicated by the dashed line arrows in FIG. 1.

The revolution of the rotating body 7 and the switching of the rotary valves 8 and 9 are performed at relatively high-speed number of revolutions and timing, the heat transfer medium (water) is reciprocated between the high-temperature end 14 and the low-temperature end 16 of each of the magnetic working bodies 11A, 11B, 11C, and 11D, and heat absorption/heat dissipation from the magnetic working substances 13 of each of the magnetic working bodies 11A, 11B, 11C, and 11D to be magnetized/demagnetized is repeated, whereby a temperature difference between the high-temperature end 14 and the low-temperature end 16 of each of the magnetic working bodies 11A, 11B, 11C, and 11D gradually increases. Then, the temperature of the low-temperature end 16 of each of the magnetic working bodies 11A, 11B, 11C, and 11D connected to the heat exchanger 28 on the heat absorption side decreases to a temperature at which the refrigerating capacity of the magnetic working substances 13 and a heat load of the cooling target body 31 are balanced, and then the heat dissipation capability and the refrigerating capacity of the heat exchanger 21 are balanced so that the temperature of the high-temperature end 14 of each of the magnetic working bodies 11A, 11B, 11C, and 11D connected to the heat exchanger on the heat dissipation side becomes a substantially constant temperature.

(3) Heat Exchangers 21 and 28

As described above, the temperature difference between the high-temperature end 14 and the low-temperature end 16 of each of the magnetic working bodies 11A to 11D increases by the repetition of heat absorption/heat dissipation. When a temperature difference balanced with the capability of the magnetic working substances 13 is reached, the temperature change is saturated. Herein, FIG. 3 illustrates the temperatures of the high-temperature end 14 and the low-temperature end 16 in the state where the temperature change is saturated as described above by L1 and L2. As is clear from the figure, both the high-temperature end 14 and the low-temperature end 16 are affected by the heat absorption and the heat dissipation by magnetization and demagnetization and the temperatures fluctuate with a predetermined temperature width (about 2 K in the example).

In the example, both or either one of the heat exchanger 21 on the heat dissipation side and the heat exchanger 28 on the heat absorption side is configured by a micro channel type heat exchanger so that heat can be exchanged with the outside (outdoor air or the cooling target body 31) with such a small temperature difference. The micro channel type heat exchanger has a higher heat transfer coefficient and also has a larger heat transfer area per unit volume as compared with those of heat exchangers of the other types, and therefore is excessively suitable for obtaining required capabilities by the magnetic heat pump device 1 as with the present invention.

(4) Magnetic Working Substances 13 of Magnetic Working Bodies 11A to 11D (Cascade Connection)

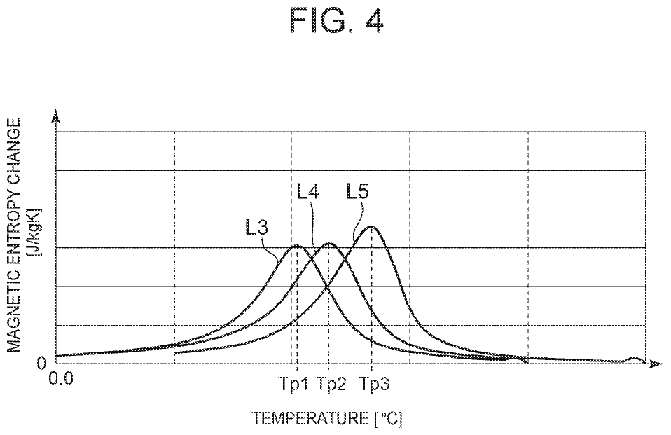

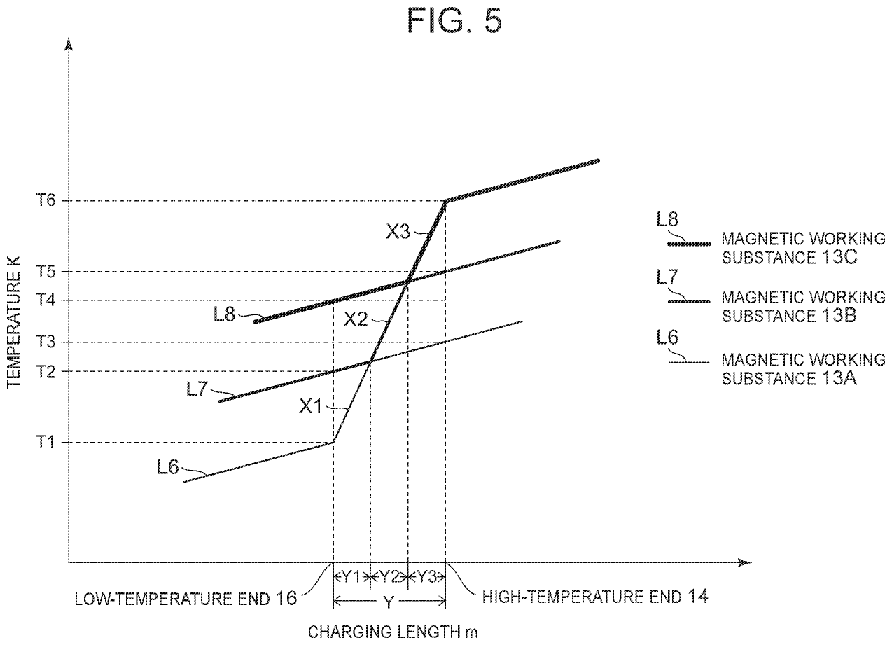

Next, the cascade connection of the first to third magnetic working substances 13A, 13B, and 13C to be charged into the duct 12 of each of the magnetic working bodies 11A to 11D is described with reference to FIGS. 4 and 5. As described above, the plurality of types of magnetic working substances configuring the magnetic working substance 13 (three types of the first to third magnetic working substances 13A, 13B, and 13C in the example) are individually charged into the duct 12 formed of resin of each of the magnetic working bodies 11A to 11D in cascade connection.

FIG. 4 illustrates a T·(−ΔS) diagram of each of the magnetic working substances 13A to 13C in the example. T represents the temperature (K or ° C.) and (−ΔS) represents the magnetic entropy change (J/kgK). In the example, three types of Mn-based or La-based materials are used as the first to third magnetic working substances 13A to 13C. The Mn-based and La-based materials have larger magnetic entropy changes (−ΔS) by magnetization/demagnetization and also have higher heat absorption/heat dissipation capabilities as compared with those of a Gd-based material used heretofore. However, the operating temperature region (drive temperature span) of each material is narrower than that of the Gd-based material. Therefore, when used alone, the temperature cannot be changed from room temperature to a required refrigerating/heat dissipation temperature (hot-water supply or the like).

More specifically, L3 in FIG. 4 represents the physical property of the first magnetic working substances 13A, L4 represents the physical property of the second magnetic working substances 13B, and L5 represents the physical property of the third magnetic working substances 13C. The first magnetic working substance 13A in the example is a second order phase transition material having a Curie point Tc1 which is a magnetic phase transition point. The second magnetic working substance 13B is a second order phase transition material having a Curie point Tc2. The third magnetic working substance 13C is a second order phase transition material having a Curie point Tc3.

As illustrated in FIG. 4, the magnetic entropy change (−ΔS) of the first magnetic working substances 13A has a peak value (−ΔSMax) at a temperature Tp1 around the Curie point Tc1 of a certain magnetic flux density (T). The magnetic entropy change (−ΔS) of the second magnetic working substances 13B has a peak value (−ΔSMax) at a temperature Tp2 around the Curie point Tc2 of a certain magnetic flux density (T). The magnetic entropy change (−ΔS) of the third magnetic working substances 13C has a peak value (−ΔSMax) at a temperature Tp3 around the Curie point Tc3 of a certain magnetic flux density (T). As is clear from FIG. 4, the magnetic entropy change (−ΔS) of each of the magnetic working substances 13A to 13C of the vertical axis has a relatively steep chevron shape with the peak value (−ΔSMax) around the Curie point thereof as the peak to the temperature of the horizontal axis.

In the example, the magnetic working substances 13A to 13C are first selected so that the Curie points establish the relationship of Tc1<Tc2<Tc3, the first magnetic working substances 13A having the lowest Curie point Tc1 are charged into the low-temperature end 16 side in the duct 12 of each of the magnetic working bodies 11A to 11D, the third magnetic working substances 13C having the highest Curie point Tc3 are charged into the high-temperature end 14 side in the duct 12 of each of the magnetic working bodies 11A to 11D, the second magnetic working substances 13B having the intermediate Curie point Tc2 are charged between the first magnetic working substances 13A and the third magnetic working substances 13C in the duct 12 of each of the magnetic working bodies 11A to 11D, and then the magnetic working substances 13A to 13C are connected in cascade, whereby the magnetic working substances 13 are configured.

More specifically, in the magnetic working substances 13 in the duct 12 of each of the magnetic working bodies 11A to 11D, the magnetic working substances 13A to 13C are connected in cascade in such a manner that the first magnetic working substances 13A (having the lowest Curie point Tc1), the second magnetic working substances 13B (having the intermediate Curie point Tc2), and the third magnetic working substances 13C (having the highest Curie point Tc3) are charged in this order from the low-temperature end 16 side to the high-temperature end 14 side.

Herein, the half width ΔT of the magnetic entropy change (−ΔS) as the index indicating a temperature width in which the magnetic working substances are effective is mentioned. The half width ΔT is a temperature change range of a 1/2 (−ΔS) value of the peak value (−ΔSMax) of the T·(−ΔS) curve illustrated in FIG. 4. The half width ΔT is an operating temperature region (or operating temperature width) of the magnetic working substances.

Since the magnetic entropy change (−ΔS) of each of the magnetic working substances 13A to 13C has a relatively steep chevron shape with the peak value (−ΔSMax) as the peak as described above, the half width ΔT which is the operating temperature region is also narrow. However, the temperature change is large in the range from the half temperature on the high temperature side of the half width ΔT (half temperature on the high temperature side from the peak value (−ΔSMax)) to the temperature at which the peak value (−ΔSMax) is reached (illustrated in the range sandwiched between the two dashed lines drawn to the L3 in FIG. 4). FIG. 5 illustrates the range corresponding to a length Y, which is the length from the low-temperature end 16 to the high-temperature end 14 of each of the magnetic working bodies 11A to 11D.

The horizontal axis of FIG. 5 represents the charging length of each of the magnetic working substances 13A to 13C. The position of the length Y from the low-temperature end 16 as the base point is the high-temperature end 14. L6 in the figure represents the temperature of each portion from the low-temperature end 16 to the high-temperature end 14 when the first magnetic working substances 13A are charged from the low-temperature end 16 to the high-temperature end 14 and the temperature change is saturated as described above. L7 similarly represents the temperature of each portion when the second magnetic working substances 13B are charged from the low-temperature end 16 to the high-temperature end 14. L8 similarly represents the temperature of each portion when the third magnetic working substances 13C are charged from the low-temperature end 16 to the high-temperature end 14.

X1 in the figure represents the range in which the temperature change is large of the first magnetic working substances 13A described above (from the half temperature on the high temperature side of the half-width ΔT to the peak value (−ΔSMax): hereinafter referred to as a specific temperature range). X2 represents a specific temperature range in which the temperature change is large of the second magnetic working substances 13B. X3 represents a specific temperature range in which the temperature change is large of the third magnetic working substances 13C. In the specific temperature ranges X1 to X3, the temperature change is larger than that in the other portions in the magnetic working substances charged from the low-temperature end 16 to the high-temperature end 14.

However, when the first magnetic working substances 13A are charged alone from the low-temperature end 16 to the high-temperature end 14, only the temperature change from the temperature T1 of the low-temperature end 16 to the temperature T3 of the high-temperature end 14 is obtained (L6). When the second magnetic working substances 13B are charged alone from the low-temperature end 16 to the high-temperature end 14, only the temperature change from the temperature T2 of the low-temperature end 16 to the temperature T5 of the high-temperature end 14 is obtained (L7). Furthermore, it is found from FIG. 5 that, when the third magnetic working substances 13C are charged alone from the low-temperature end 16 to the high-temperature end 14, only the temperature change from the temperature T4 of the low-temperature end 16 to the temperature T6 of the high-temperature end 14 is obtained (L8).

Thus, the magnetic working substances 13A to 13C are charged into the ducts 12 in such a manner that the specific temperature ranges X1 to X3 in which the temperature change is large described above of the magnetic working substances 13A to 13C are connected in order from lowest to highest in the present invention.

First, the magnetic working substances having the physical properties that the upper boundary point of the specific temperature range of the first magnetic working substances 13A coincides with or approximates the lower boundary point of the specific temperature range of the second magnetic working substances 13B, the upper boundary point of the specific temperature range of the second magnetic working substances 13B coincides with or approximates the lower boundary point of the specific temperature range of the third magnetic working substances 13C, and a required temperature change (temperature change from the temperature T1 to the temperature T6 of FIG. 5) is obtained in the range from the lower boundary point or the vicinity thereof of the specific temperature range of the first magnetic working substances 13A to the upper boundary point or the vicinity thereof of the specific temperature range of the third magnetic working substances 13C are selected as the first to third magnetic working substances 13A to 13C.

When the first magnetic working substances 13A having the lowest Curie point Tc1 are charged into the duct 12 from the low-temperature end 16 to the position of the length Y1 in FIG. 5, the second magnetic working substances 13B having the second highest Curie point Tc2 are charged into the duct 12 from the position of the length Y1 to the position of the length Y2, and the third magnetic working substances 13C having the highest Curie point Tc3 are charged into the duct 12 from the position of the length Y2 to the high-temperature end 14 (position of the length Y from the low-temperature end 16) and connected in cascade, the specific temperature range X1 in which the temperature change is large of the first magnetic working substances 13A is made to correspond to the dimension from the low-temperature end 16 to the position of the length Y1, the specific temperature range X2 in which the temperature change is large of the second magnetic working substances 13B is made to correspond to the dimension from the position of the length Y1 to the position of the length Y2, and the specific temperature range X3 in which the temperature change is large of the third magnetic working substances 13C is made to correspond to the dimension from the position of the length Y2 to the position of the length Y3 (position of the high-temperature end 14).

Thus, even when the Mn-based and La-based magnetic working substances 13A to 13C having narrow operating temperature regions are used, the largest temperature change from the temperature T1 of the low-temperature end 16 to the temperature T6 of the high-temperature end 14 is obtained as illustrated in FIG. 5 by most effectively connecting the substances 13A to 13C in cascade. Thus, the temperature has been able to be lowered to a cooling temperature or increased to a heat dissipation temperature for heating, hot-water supply, and the like required as a heat pump.

(5) Parallel Connection of Magnetic Heat Pump Devices 1

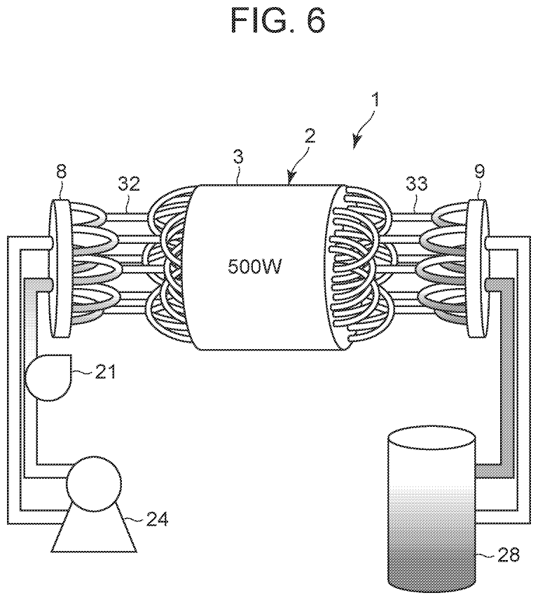

Next, FIG. 6 illustrates an example of the magnetic heat pump device 1 in which the target refrigerating capacity is set to 500 W and which is configured by one magnetic heat pump AMR 2. In order to obtain such a large output, a large-sized housing 3 is required and the number of pipes 32 and 33 (high-temperature pipes and low-temperature pipes in the example described above) connected thereto also reaches an excessively large number, so that the number of components increases. Moreover, the rotary valves 8 and 9 are also enlarged, which poses a problem that the structure is also complicated.

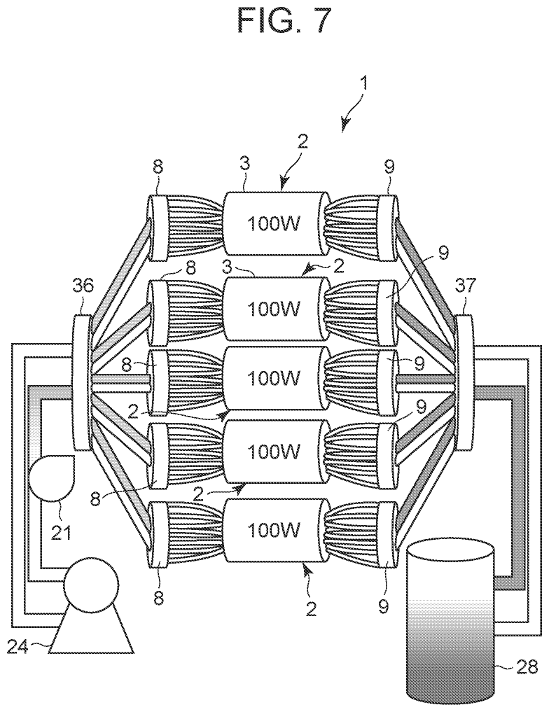

On the other hand, when five sets of the magnetic heat pump AMR 2 (housing 3) and the rotary valves 8 and 9 of the magnetic heat pump device 1 for 100 W of the example of FIG. 1 are prepared and are connected in parallel between rotary valves 36 and 37 as illustrated in FIG. 7, the number of the pipes can be reduced and the size of the rotary valves 8, 9, 36, and 37 can also be reduced as compared with the case of FIG. 6. Moreover, dead space also decreases and the loss of heat transferred from the pipes is also reduced. Furthermore, the magnetic heat pump device 1 for 500 W can be configured by using the magnetic heat pump AMR 2 for 100 W, and therefore the cost required for the design and the production can also be reduced.

In the example, the magnetic working substance 13 is configured by connecting the three types of magnetic working substances 13A to 13C in cascade but two types or four types or more of magnetic working substances may be connected in cascade in accordance with the target refrigerating capacity without being limited thereto. Also in the case, each of the magnetic working substances is charged into the duct 12 without deviating from the gist of the present invention.

The entire configuration of the magnetic heat pump device is also not limited to the example and the heat transfer medium moving device may be configured by a so-called displacer in place of the circulating pump 24 or the rotary valves 8 and 9.

### DESCRIPTION OF REFERENCE NUMERALS

1 magnetic heat pump device

2 magnetic heat pump AMR

3 housing

6 permanent magnet (magnetic field changing device)

7 rotating body (magnetic field changing device)

8, 9 rotary valve (heat transfer medium moving device)

11A to 11D magnetic working body

12 duct

13, 13A to 13C magnetic working substance

14 high-temperature end

16 low-temperature end

21, 28 heat exchanger

24 circulating pump (heat transfer medium moving device)

1. A magnetic heat pump device comprising:
a magnetic working body obtained by charging a magnetic working substance having a magnetocaloric effect into a duct in which a heat transfer medium is circulated;
a magnetic field changing device changing a size of a magnetic field to be applied to the magnetic working substance;
a heat transfer medium moving device moving the heat transfer medium between a high-temperature end and a low-temperature end of the magnetic working body;
a heat exchanger on a heat dissipation side for causing the heat transfer medium on a side of the high-temperature end to dissipate heat; and
a heat exchanger on a heat absorption side for causing the heat transfer medium on a side of the low-temperature end to absorb heat, wherein
two or more types of the magnetic working substances are connected in cascade by charging the magnetic working substances into the duct of the magnetic working body in an ascending order of Curie points from the low-temperature end to the high-temperature end, and
a dimension in which each of the magnetic working substances is charged is made to correspond to a specific temperature range in which a temperature change is large of each of the magnetic working substances.

2. The magnetic heat pump device according to claim 1, wherein
the specific temperature range in which the temperature change is large of each of the magnetic working substances is a range from a half temperature on a high temperature side of a half width to a temperature at which a magnetic entropy change reaches the peak value of each of the magnetic working substances.

3. The magnetic heat pump device according to claim 1, wherein
the specific temperature range in which the temperature change is large of each of the magnetic working substances is a range in which, when each of the magnetic working substances is charged into the duct alone, the temperature change is larger than a temperature change in another portion between the low-temperature end and the high-temperature end when the temperature change is saturated.

4. The magnetic heat pump device according to claim 1, wherein
the magnetic working substances are charged into the duct so that the specific temperature ranges of the magnetic working substances are connected in order from lowest to highest.

5. The magnetic heat pump device according to claim 1, wherein
each of the magnetic working substances is a material having a magnetic entropy change larger than a magnetic entropy change of a Gd-based material but having an operating temperature region narrower than an operating temperature region of the Gd-based material.

6. The magnetic heat pump device according to claim 5, wherein
each of the magnetic working substances is an Mn-based or La-based material.

7. The magnetic heat pump device according to claim 1, wherein
the duct is configured by a resin.
